(19) United States
(12) Patent Application Publication
(10) Pub. No.: US 2008/0092032 A1
(43) Pub. Date: Apr. 17, 2008

(54) WEB PAGE DEVELOPMENT ENVIRONMENT THAT DISPLAYS FREQUENCY OF USE INFORMATION

(75) Inventors: Cary Lee Bates, Rochester, MN (US); Paul W. Buenger, Eau Claire, WI (US)

Correspondence Address: MARTIN & ASSOCIATES, LLC, P.O. BOX 548, CARTHAGE, MO, 64836-0548, US

(73) Assignee: International Business Machines Corporation, Armonk, NY (US)

(21) Appl. No.: 11/955,388

(22) Filed: Dec. 13, 2007

Related U.S. Application Data
(62) Division of application No. 10/687,473, filed on Oct. 16, 2003.

(51) Int. Cl. G06F 17/00

(52) U.S. Cl. 715/205

(57) ABSTRACT

A web page development environment includes a link disambiguator that assures each link in a web page may be uniquely identified in an access log. An editor reviews the access log and displays a web page in a manner to visually indicate how often certain portions of the web page are used in certain ways. For example, links are highlighted to visually indicate their frequency of use. In addition, text within a web page that was used as a search term to find the web page is highlighted. Note that the highlighting may include any suitable visual indication of frequency of use.

### CROSS-REFERENCE TO RELATED APPLICATION

This patent application is a divisional of a patent application with the same title, U.S. ser. No. 10/687,473 filed on Oct. 16, 2003, which is incorporated herein by reference.

### BACKGROUND OF THE INVENTION

1. Technical Field

This invention generally relates to computer systems, and more specifically relates to apparatus and methods for developing web pages.

2. Background Art

The widespread proliferation of computers in our modern society has prompted the development of computer networks that allow computers to communicate with each other. With the introduction of the personal computer (PC), computing became accessible to large numbers of people. Networks for personal computers were developed that allow individual users to communicate with each other. In this manner, a large number of people within a company could communicate with other computers on the network.

One significant computer network that has recently become very popular is the Internet. The Internet grew out of this proliferation of computers and networks, and has evolved into a sophisticated worldwide network of computer system resources commonly known as the “world-wide-web”, or WWW. A user at an individual PC (i.e., workstation) that wishes to access the Internet typically does so using a software application known as a web browser. A web browser makes a connection via the Internet to other computers known as web servers, and receives information from the web servers that is displayed on the user's workstation. Information transmitted from the web server to the web browser is generally formatted using a specialized language called Hypertext Markup Language (HTML) and is typically organized into pages known as web pages. Many web pages include several individual components, such as text, banners, graphical images, Java applets, audio links, video links, and other components that present the web page to the user in a desired way. A designer of a web page can select a unique combination of components to provide the user with a desired overall presentation of the web page.

Certain software tools have evolved that help web page developers generate web pages. Some of these tools are known as Integrated Development Environments (IDEs). An IDE is typically menu-driven, and allows a user to easily generate a web page, and to edit existing web pages. Editors within IDEs typically provide a “what you see is what you get” view of a web page. However, none of the existing editors or IDEs provide tools that provide the user feedback regarding how the page has been accessed in the past. As a result, a web page designer may decide to modify the content or arrangement of a web page, and could change the look and feel of the website. For example, if the web page designer decides to move some links on a web page, and those links are the most commonly used links, the result may be frustration for many users of the web site that now have to hunt for the new link location. Without a way to indicate frequency of use information for one or more parts of a web page within a web page editor, web page designers will not have any information regarding frequency of use when modifying a web page.

### DISCLOSURE OF INVENTION

According to the preferred embodiments, a web page development environment includes a link disambiguator that assures each link in a web page may be uniquely identified in an access log. An editor reviews the access log and displays a web page in a manner to visually indicate how often certain portions of the web page are used in certain ways. For example, links are highlighted to visually indicate their frequency of use. In addition, text within a web page that was used as a search term to find the web page is highlighted. Note that the highlighting may include any suitable visual indication of frequency of use.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is a flow diagram of a method in accordance with the preferred embodiments for editing a web page;

FIG. 3 is a flow diagram of a method in accordance with the preferred embodiments for publishing a web page;

FIG. 4 is a flow diagram of a first method for disambiguating links in accordance with the preferred embodiments;

FIG. 5 is a flow diagram of a second method for disambiguating links in accordance with the preferred embodiments;

FIG. 6 is a flow diagram of a third method for disambiguating links in accordance with the preferred embodiments;

FIG. 7 is a flow diagram of a method in accordance with the preferred embodiments for highlighting one or more words when displaying a web page to indicate frequency of use of keywords used to invoke the web page;

FIG. 8 shows a sample web page for the sake of illustrating the preferred embodiments;

FIG. 9 shows a sample access log for the web page of FIG. 8 after the links have been disambiguated using the first method of FIG. 4;

FIG. 10 shows a sample access log for the web page of FIG. 8 after the links have been disambiguated using the second method of FIG. 5;

FIG. 11 shows a sample access log for the web page of FIG. 8 after the links have been disambiguated using the third method of FIG. 6;

FIG. 12 shows the web page of FIG. 8 when displayed in accordance with the preferred embodiments in a manner that highlights frequency of use for the links in the web page according to the access logs in FIGS. 9-11;

FIG. 13 shows a sample access log that includes search results that specify key words used to invoked a web page; and

FIG. 14 shows the web page of FIG. 8 when displayed in accordance with the preferred embodiments in a manner that highlights frequency of use for the words in the web page as keywords used to invoke the web page according to the access log in FIG. 13.

### BEST MODE FOR CARRYING OUT THE INVENTION

The present invention provides a visual indication to a web page designer of the frequency of which certain portions of a web page have been used in the past based on historical information contained in an access log. This information will help the web page designer avoid deleting words that are often used as keywords in search engines to invoke the web page, and will help the web page designer see which links are most frequently used in the web page.

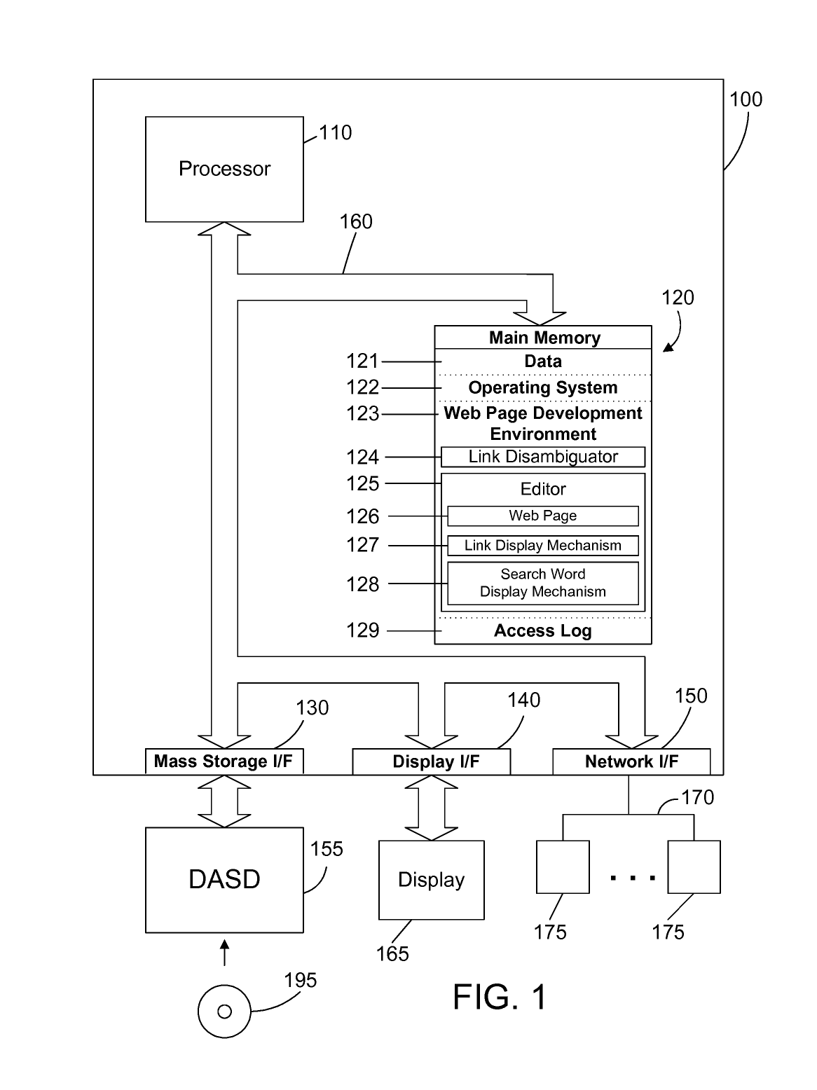

Referring to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices (such as a direct access storage device 155) to computer system 100. One specific type of direct access storage device 155 is a readable and writable CD RW drive, which may store data to and read data from a CD RW 195.

Main memory 120 in accordance with the preferred embodiments contains data 121, an operating system 122, a web page development environment 123, and an access log 129. Data 121 represents any data that serves as input to or output from any program in computer system 100. Operating system 122 is a multitasking operating system known in the industry as OS/400; however, those skilled in the art will appreciate that the spirit and scope of the present invention is not limited to any one operating system.

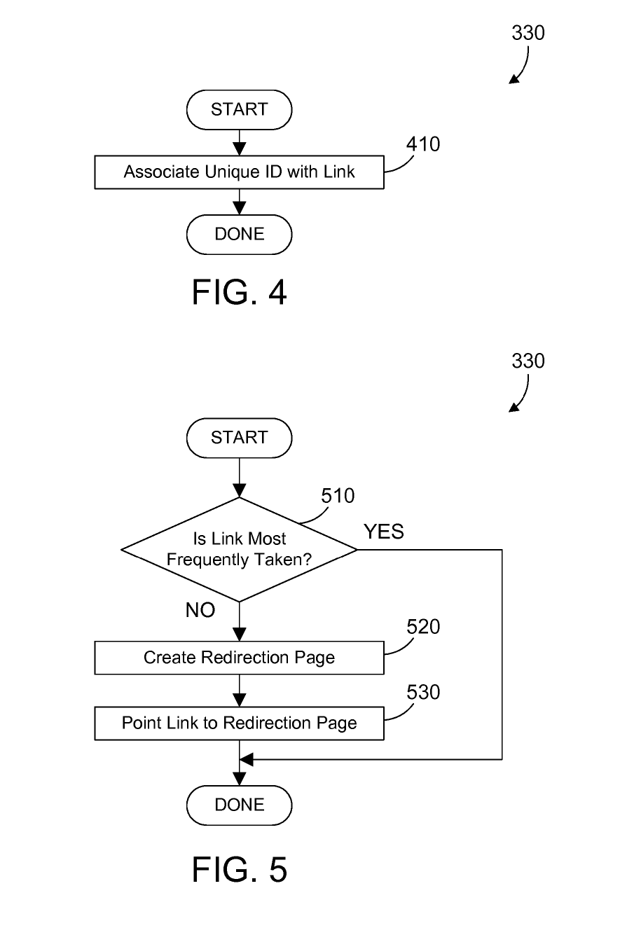

Web page development environment 123 is a powerful tool for developing and publishing web pages. It is similar in many respects to Integrated Development Environments (IDE) known in the art, but includes many new features of the preferred embodiments. Web page development environment 123 includes a link disambiguator 124 and an editor 125. Link disambiguator 124 is used to process a web page (e.g., web page 126) before the web page is published for use to assure that each link in the web page is unique. There are various different ways the disambiguator 124 can guarantee that each link in the web page is unique, which are discussed in more detail below with reference to FIGS. 4-6.

Editor 125 displays a web page 126, and includes a link display mechanism 127 and a search word display mechanism 128. The access log 129 is a log file corresponding to web page 126 that contains a history of accesses to the web page. Access log 129 may be in any suitable form and format. In the preferred implementation, access log 129 is a common log for all pages at a given web site. The link display mechanism 127 determines frequency of use information from the access log 129 for each link on the web page 126, and highlights the links according to their frequency of use to provide a visual indication to the web page designer which links are the most frequently used. Because the link disambiguator 124 guarantees that each link in the web page is unique, the access log will contain information for each individual link in the web page, even if they point to the same page or to copies of the same page. The search word display mechanism 128 determines frequency of use information from the access log 129 regarding whether and how often each word in the web page 126 has been used as a search term (keyword) for invoking the web page. In this manner, a web page 126 displayed by editor 125 will contain visual indications of which portions of the web page 126 have been used in the past to help the web page designer make intelligent decisions about redesign of the web page.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, web page development environment 123, and access log 129 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable signal bearing media used to actually carry out the distribution. Examples of suitable computer-readable signal bearing media include: recordable type media such as floppy disks and CD RW (e.g., 195 of FIG. 1), and transmission type media such as digital and analog communications links.

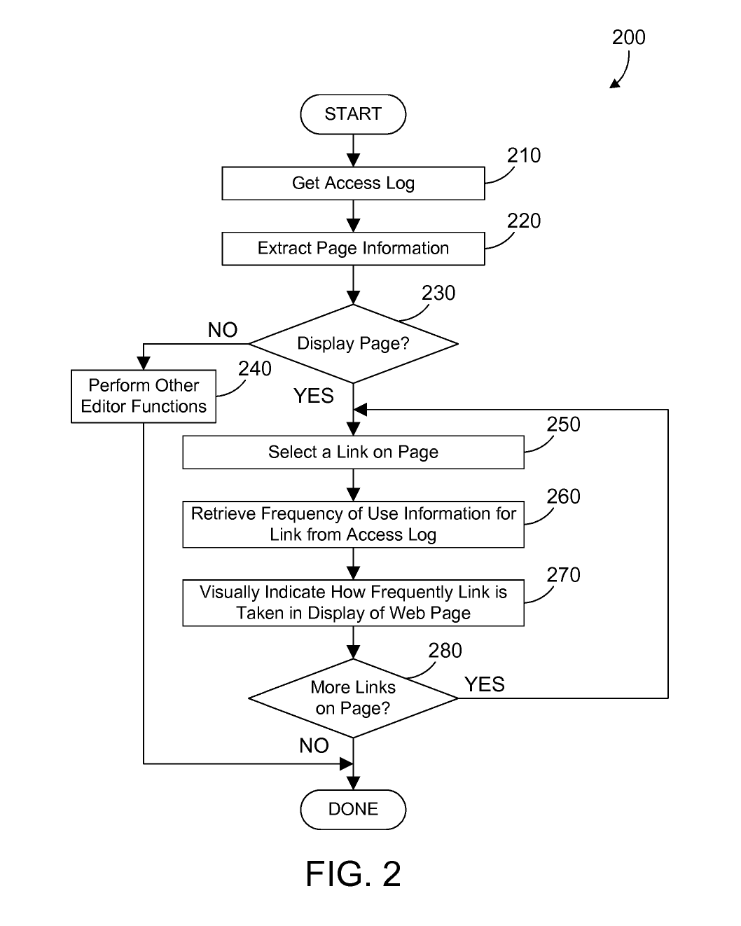

The preferred embodiments provide a significant advance in the art by providing visual indication to a web page designer of which portions of the web page have been used in the past based on historical information from an access log. Referring to FIG. 2, a method 200 in accordance with the preferred embodiments is a method for editing a web page. Method 200 is thus preferably performed by editor 125 in FIG. 1. The first step is to get the access log that corresponds to the web page to be displayed (step 210). We assume this access log includes information for all web pages within a given web site. The information for the selected page is extracted from the access log (step 220). If the desired editor function is to display the page (step 230=YES), a link on the page is selected (step 250), frequency of use information for the link is retrieved from the access log (step 260), and the link is modified in the display to visually indicate how frequently the link was taken (step 270). This visual indication is generally referred to herein as “highlighting.” Note that the term “highlighting” herein is used in a very broad sense to refer to any visual indication that is capable of communicating frequency of use information. For example, the font style and size could be changed. Different colors could indicate frequency of use information, such as highlighting the most frequency used links in red (hot links), and going down the color spectrum and highlighting the least frequently used links (or links that are not used) in blue (cool links). Both background and foreground colors may be changed. In addition, the text may be made to flash or blink. Indicators may be added in the web page to visually indicate frequency of use, such as a small thermometer next to each link indicating how hot the link is (i.e., the frequency of use for the link). Of course, other visual indications are possible, and are all expressly within the scope of the preferred embodiments, which extends to any and all ways to visually indicate frequency of use information while displaying a web page.

If there are more links on the web page to process (step 280=YES), method 200 returns to step 250 and continues until all links on the web page have been processed (step 280=NO). Note that if the editor function is not to display the web page (step 230=NO), the other specified editor function is performed (step 240). Method 200 thus processes links in a web page and highlights those links according to their frequency of use in the access log corresponding to the web page.

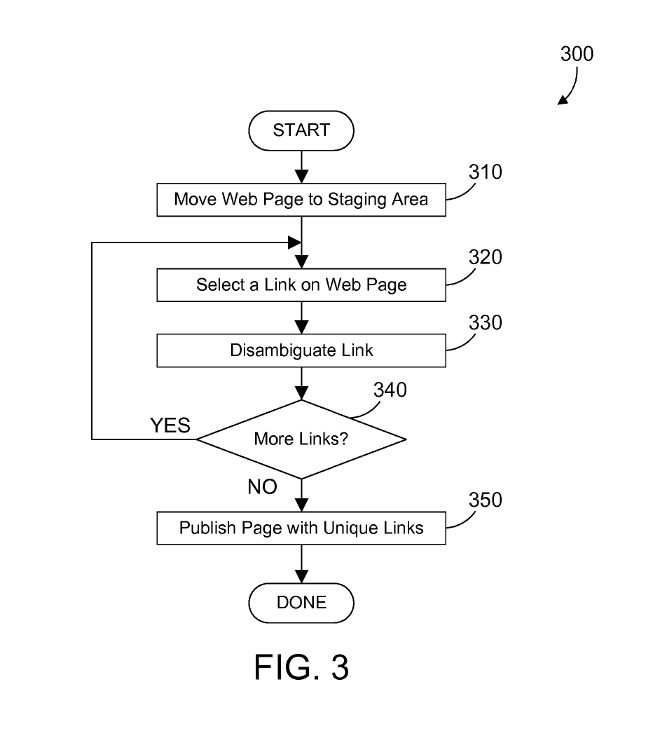

Some links in a web page may be identical. For example, it is common practice to put a menu of links on a web page, and to put a list of those same links at the bottom of the page as well. A link “Products” in the main part of the web page would typically be identical to the link “Products” at the bottom of the web page. Thus, if we say we are interested in the frequency of use of the “Products” link, this is ambiguous because there are two identical links for “Products”. To distinguish between these two identical links, we need to “disambiguate” these links, which means we need to be able to tell which of the identical links are taken in the access log. This disambiguation of links is preferably performed before a web page is published (i.e., made available for use). Referring to FIG. 3, a method 300 for publishing a web page starts by moving the web page to the staging area (step 310). A link on the web page is selected (step 320), and the link is disambiguated (step 330). The step of disambiguating links determines whether there are multiple identical links on the web page, and if so, creates unique links to replace the multiple identical links. If there are more links to process (step 340=YES), method 300 loops back to step 320 and continues until all links have been processed (step 340=NO). Once all links have been disambiguated, the page is published with its unique links (step 350).

There are different ways to disambiguate links. The preferred embodiments expressly extend to any and all methods for assuring that links in a web page are unique. Three specific implementations of step 330 in FIG. 3 are shown in FIGS. 4-6. Referring to FIG. 4, a first way to disambiguate the links is to associate an identifier with the link (step 410). This can be easily done by appending “?id=X” to the link, where X is an integer identifier. Referring to FIG. 5, a second way to disambiguate the links is to determine whether the selected link is the most frequently taken (step 510). If so, (step 510=YES) no action is required, because the most frequently taken link is allowed to keeps its original name. If the link is not the most frequently taken (step 510=NO), a redirection page is created (step 520), and the link is made to point to the redirection page (step 530). Now when this link is invoked, it will go to the redirection page, which will redirect it to the original page. The redirection page is unique, and thus allows the frequency of use for the link to be determined from the access log.

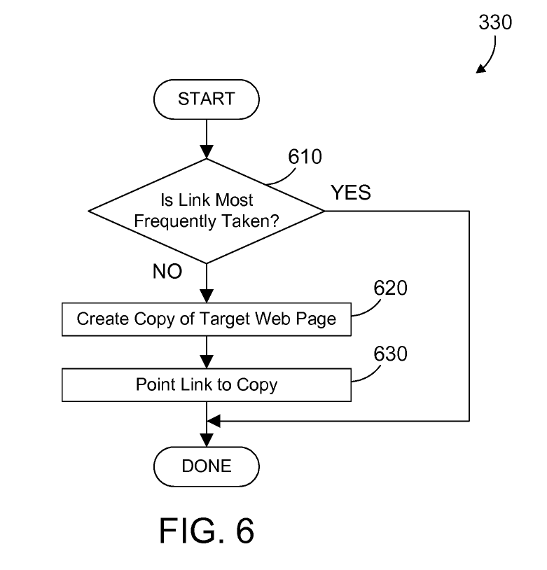

Referring to FIG. 6, a third way to disambiguate the links is to determine whether the selected link is the most frequently taken (step 610). If so (step 610=YES), no action is required, because the most frequently taken link is allowed to keep its original name. If the link is not the most frequently taken (step 610=NO), a copy of the web page the link points to (the target web page) is created (step 620), and the link is changed to point to the copy (step 630). By creating copies of web pages for each identical link, each link now points to its own unique copy. This allows the frequency of use information for each link to be retrieved from the access log.

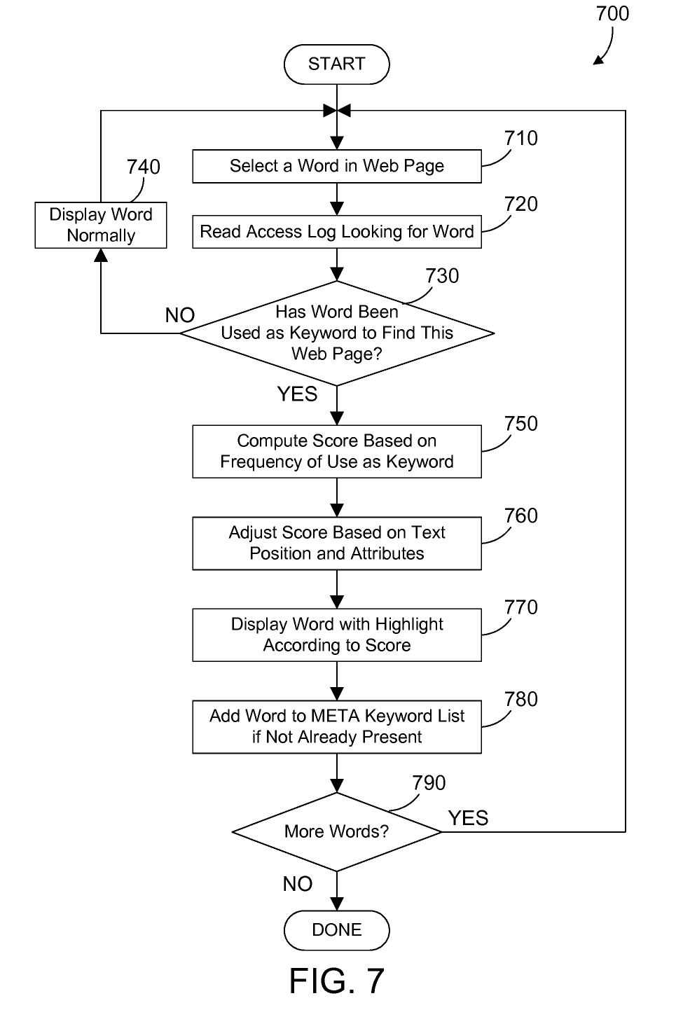

Other important information that is contained in an access log is the search terms that were used to invoke a web page. By analyzing the search terms in the access log, those terms in the web page may be highlighted to indicate the frequency with which those terms were used as keywords in a search to locate and invoke the web page. Referring now to FIG. 7, a method 700 in accordance with the preferred embodiments highlights words according to their frequency of use as search terms (or keywords) used to invoked the web page, as indicated in the access log. A word in the web page is selected (step 710). The access log is then read, looking for the word as a keyword used in a search (step 720). If the word has not been used as a keyword to find this web page (step 730=NO), the word is displayed normally (step 740). If the word has been used as a keyword to find this web page (step 730=YES), a score is computed based on frequency of use as a keyword (step 750). The score is then adjusted based on text position and attributes in the web page (step 760). It is common for search engines to given more weight to some portions of the web page than others. Thus, if the word is at the top of the web page, the score may be adjusted to reflect a greater score. The word is then displayed with a highlight according to its score (step 770). The word is also automatically added to the META keyword list if the word is not already present in the list (step 780). If there are more words to process (step 790=YES), method 700 loops back to step 710 and continues until there are no more words on the web page to process (step 790=NO).

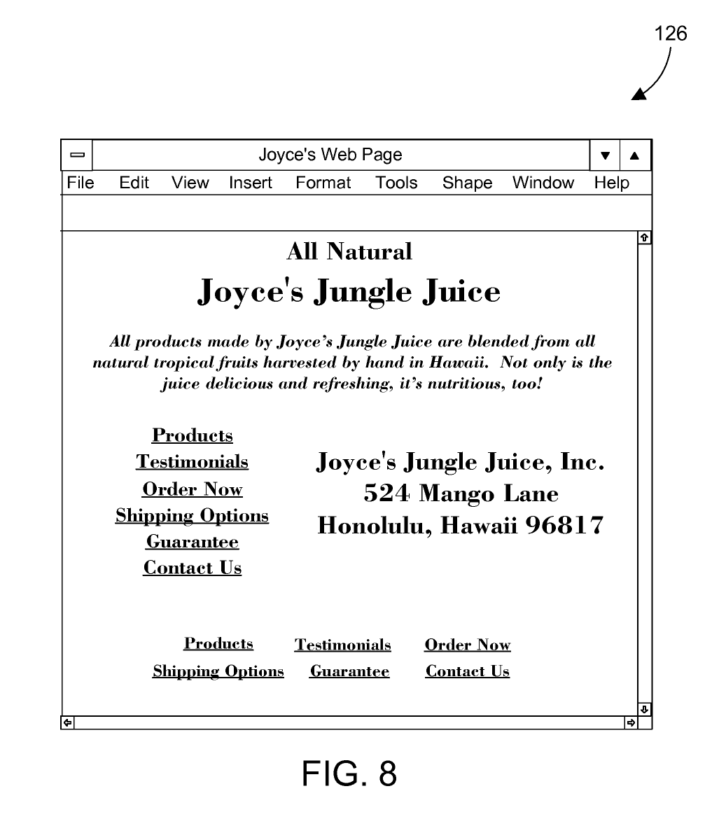

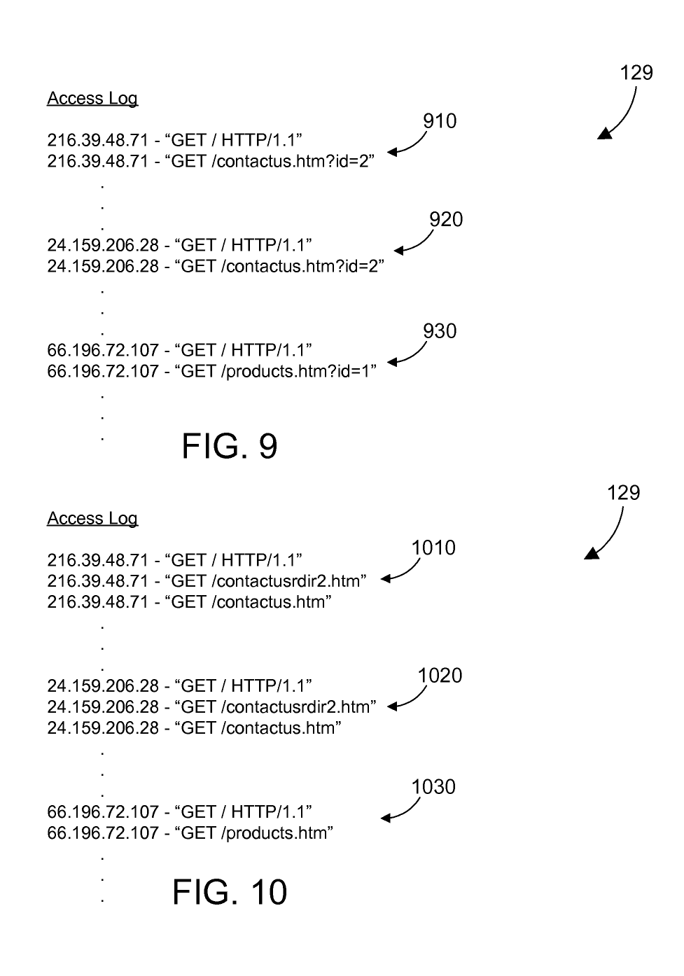

Examples are now presented to visually illustrate the concepts of the preferred embodiments. A sample web page 125 is shown in FIG. 8. We assume this is the web page as displayed when a user invokes the web page. Note there are links on the left side of the web page that are duplicated at the bottom of the web page. We now show three different examples of access logs that illustrate the three corresponding ways of disambiguating links shown in FIGS. 4-6. If the duplicate links in web page 125 in FIG. 8 are disambiguated as shown in FIG. 4 by associating a unique identifier with each duplicate link, the links at the left of the page will have different unique identifiers than the links at the bottom of the page. We assume that the links at the left of the page have the text ?id=1 appended to the link, and the links at the bottom of the page have the text ?id=2 appended to the link, thus creating unique links on the web page. Referring to FIG. 9, a sample access log is shown that includes information that shows the Contact Us link at the bottom of the page (contactus.htm?id=2) was accessed twice at 910 and 920, and that shows the Products link at the left of the page (products.htm?id=1) was accessed once at 930.

If the duplicate links in web page 125 in FIG. 8 are disambiguated as shown in FIG. 5 by creating redirection pages for duplicate links, the links at the left of the page will point to different pages than the links at the bottom of the page. We assume from the placement of the links that the links on the left side are the most frequently taken, which means these links are not changed. This assumption means the links at the bottom are not the most frequently taken, and thus need to be renamed to point to a redirection page. A redirection page causes the original page to be invoked by the redirection page. By providing a redirection page for duplicate links, one can now determine from the access log which link was taken by identifying which redirection page (if any) was invoked. Referring to FIG. 10, access log 129 indicates that the Contact Us link at the bottom of the page was invoked (through a redirection page contactusrdir2.htm) at 1010 and 1020, and that the Products link at the left of the page was invoked once at 1030.

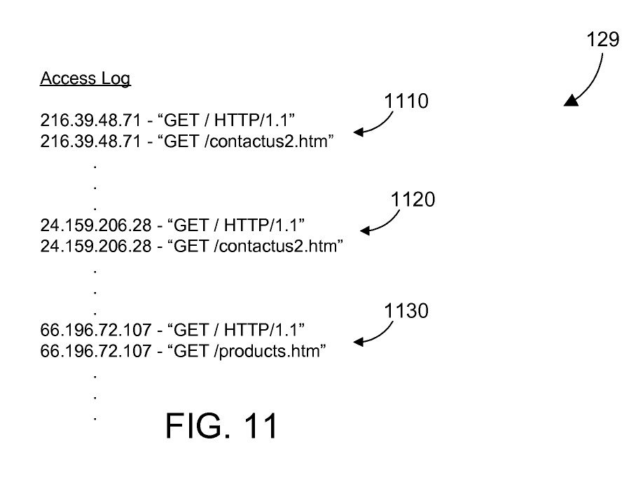

If the duplicate links in web page 125 in FIG. 8 are disambiguated as shown in FIG. 6 by creating copies of the target web page, the links at the left of the page will point to the original web pages while the links at the bottom of the page will point to the copies of the web pages, assuming the links at the left are the most frequently taken. By providing duplicate web pages, the links are now unique, and one can determine from the access log which link was taken. Referring to FIG. 11, access log 129 indicates that the Contact Us link at the bottom of the page was invoked to access the copy of the Contact Us page (contactus2.htm) at 1110 and 1120, and that the Products link at the left of the page was invoked once at 1130. Note that the access logs 129 in FIGS. 9-11 all include the same information, that the Contact Us link at the bottom of the page was accessed twice and the Products link at the left of the page was accessed once.

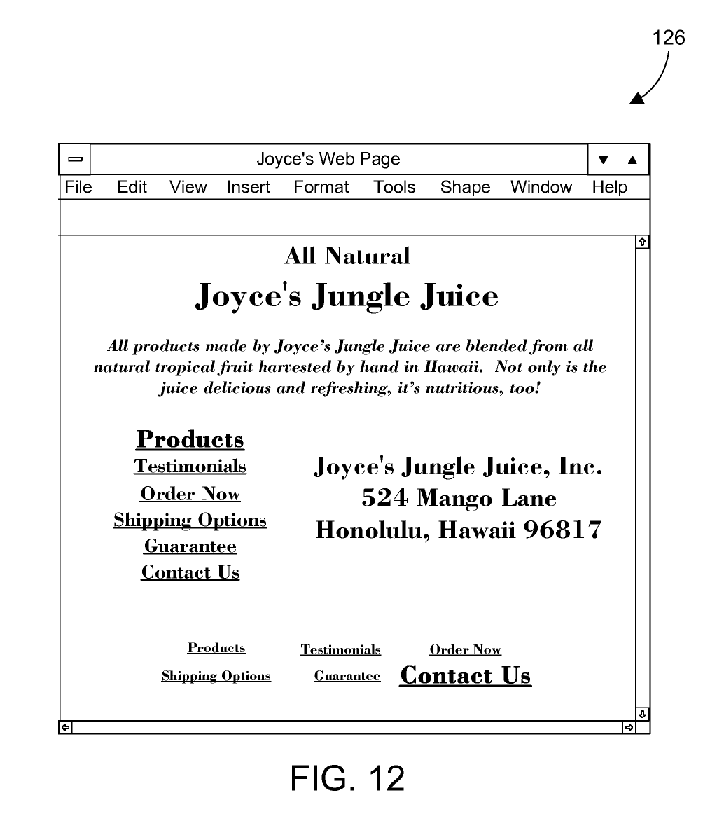

We can now visually highlight the Contact Us link at the bottom of the page and the Products link at the left of the page to indicate the frequency of use for those links according to the access log. Referring to FIG. 12, the Products link at the left of the page is increased one font size and bolded to indicate it was used once. The Contact Us link at the bottom of the page is increased two font sizes and bolded to indicate that it was used twice. The access log may thus be used to display frequency of use information for the links on a web page.

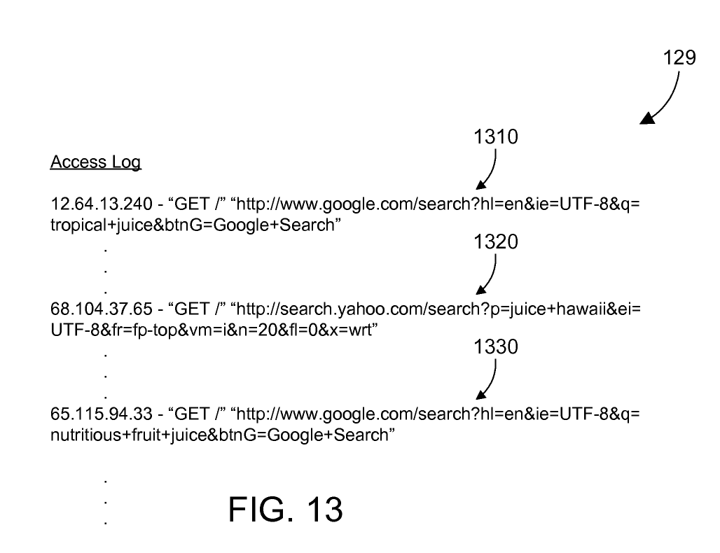

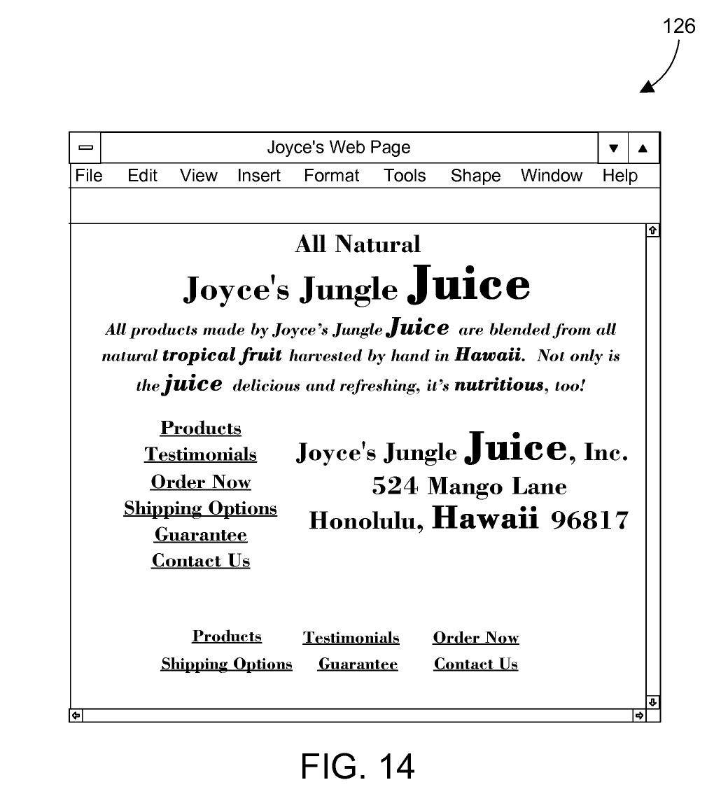

We now present an example to show how words in a web page may be highlighted to show the frequency of use of those words as search terms. The method is shown in FIG. 7, and is discussed in detail above. Referring to FIG. 13, the access log 129 includes entries that indicate search terms that were used to invoke the web page. The entry at 1310 shows the words “tropical” and “juice” were used to find the web page using the Google search engine. The entry at 1320 shows the words “juice” and “Hawaii” were used to find the web page using the Yahoo search engine. The entry at 1330 shows the words “nutritious”, “fruit” and “juice” were used to find the web page using the Google search engine. We see from these three entries 1310, 1320 and 1330 that the word “juice” was used three times, and the words “tropical”, “Hawaii”, “nutritious” and “fruit” were all used once. Referring to FIG. 14, the word “juice” in the web page is increased three font sizes and bolded to indicate its use three times, while the words “tropical”, “Hawaii”, “nutritious” and “fruit” are all increased one font size and bolded to indicate their use one time. The resulting display of web page 126 in FIG. 14 visually indicates to the web page designer the frequency of which words in the web page have been used to locate the web page using search engines. This allows the web page designer to make intelligent decisions about the deletion of text from a web page.

The highlighting of links is shown in FIG. 12, while the highlighting of text used as search terms is shown separately in FIG. 14. Note, however, that the highlighting of links and the highlighting of words that have been used as search terms may be performed simultaneously. Thus, the web page display shown in FIG. 14 could include the highlighted Products and Contact Us links shown in FIG. 12. The preferred embodiments expressly extend to the highlighting of any portion of a web page according to its frequency of use, and to the highlighting of multiple portions at the same time.

The preferred embodiments provide a significant advance in the art by displaying information regarding historical frequency of use to a web page designer to help the web page designer make intelligent decisions regarding the redesign of the web page. Hot links should probably be left in the same location so users will have the same look and feel in navigating the web site after the redesign. Words that are often used as keywords to locate the web page should probably not be removed from the web page. Using historical information to highlight portions of a web page while editing the web page is a significant advantage provided by the present invention.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. A method for publishing a web page comprising the steps of:
(A) determining whether multiple identical links exist in the web page;
(B) for each set of multiple identical links in the web page, generating from the multiple identical links a plurality of links that are unique within the web page.

2. The method of claim 1 wherein step (B) comprises the step of uniquely naming each link in the web page.

3. The method of claim 1 wherein step (B) comprises the step of creating a redirection page for each link that is identical to a first link.

4. The method of claim 1 wherein step (B) comprises the steps of:
copying and renaming a web page for each link that is identical to a first link; and
causing the link to point to the renamed web page.
